(19) United States
(12) Patent Application Publication
(10) Pub. No.: US 2005/0150294 A1
(43) Pub. Date: Jul. 14, 2005

(54) Level sensor

(75) Inventors: Stephane Bouton, Pontpierre (FR); Christophe Gette, Mecleuves (FR); Otto Korst, Hershbach (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/451,269

(22) PCT Filed: Dec. 17, 2001
(86) PCT No.: PCT/DE01/04729

(30) Foreign Application Priority Data
Dec. 22, 2000 (DE) 100 64 591.7

(51) Int. Cl. G01F 23/32

(52) U.S. Cl. 73/317

(57) ABSTRACT

A level sensor (2) comprising a support (6) with a bearing (11) for a lever arm (3) with a float (4) and a guide rail (16) pointing in the direction of the bearing (11). The lever arm (3) has a stirrup (5) made of plastic and a lever wire (7) clipped thereto. The stirrup has two guide elements (12,13) which are arranged next to each other and which engage with the guide rail (16), thereby preventing the dual contact (10) of the stirrup (5) from rising above the slideways (9) of a potentiometer (8) which are disposed on the support (6).

### CLAIM FOR PRIORITY

This application claims priority to International Application No. PCT/DE01/04729 which was published in the German language on Jul. 4, 2002.

### TECHNICAL FIELD OF THE INVENTION

The invention relates to a filling-level sensor for generating electrical signals as a function of a pivoting angle of a float-carrying lever arm for a tank of a motor vehicle.

### BACKGROUND OF THE INVENTION

Prior art filling-level sensors usually have a potentiometer with a wiping track arranged on the carrier and with wiper contacts, fastened to the yoke, for generating the electrical signals. Alternatively, the electrical signals are often also generated by means of a magnetically active position sensor. Magnetically active position sensors mostly have a resistance network which is to be fastened to the carrier and which is switchable by a magnet arranged on the yoke. The tank may be, for example, a fuel tank or a washing-water tank of a windshield cleaning system. The guide rail of the known filling-level sensor is designed as part of the carrier having a plane surface and is oriented away from the mounting. A U-shaped guide element arranged on the yoke engages behind the guide rail. This, in the case of lateral forces acting on the yoke and the lever wire, prevents the yoke from being bent away from the carrier and therefore the wiper contacts from being lifted off from the wiping track or the magnet from being removed from the resistance network.

One disadvantage of the known filling-level sensor is that, because of the guide element, the yoke has very large dimensions and is therefore heavy. As a result, the center of gravity of the yoke is at a very great distance from the mounting, and therefore the filling-level sensor is very slow-acting. Consequently, minor variations in the filling level are detected by the potentiometer only with a delay or abruptly. Moreover, because of the high weight of the yoke, the latter requires a large quantity of material.

### SUMMARY OF THE INVENTION

The invention is directed a filling-level sensor, with a carrier provided for fastening to a lateral wall in the tank, with a yoke made from plastic and pivotable in the mounting of the carrier, with a lever wire holding the float and fastened to the yoke, and with a guide rail, arranged on the carrier, for guiding a guide element of the yoke in an intended axial position in relation to the carrier. The filling-level sensor according to the invention detects a variation in the filling level particularly quickly and is constructed cost-effectively.

According to an aspect of the invention, the guide rail is arranged so as to point in the direction of the mounting, and the yoke has a fork-shaped guide element which is open at its end facing away from the mounting and engages with a guide rail.

By virtue of this design, the yoke has very small dimensions and a particularly low weight. Moreover, the center of gravity of the yoke is arranged very near the mounting, so that the yoke has particularly low inertia. The yoke can therefore follow a variation in the filling level in the tank particularly quickly. Due to the low weight of the yoke, the latter necessitates the use of a correspondingly small amount of material, so that it can be produced particularly cost-effectively.

The guide rail could, for example, have a round cross section. However, according to an aspect of the invention, the carrier can be manufactured at a particularly low outlay in one piece with the guide rail from plastic by the injection molding method if the guide rail has a web-shaped configuration and is arranged parallel to the carrier. By virtue of this configuration, the guide rail has a sliding track for the guide element on each of the two sides.

The fork-shaped guide element could, for example, be arranged in a middle region of the yoke. However, a contribution to further reducing the dimensions of the yoke is made when the fork-shaped guide element is arranged at that end of the yoke which faces away from the mounting.

The yoke is particularly reliably mounted on the carrier axially and can nevertheless be mounted on the carrier very simply when it is designed to engage around at least part of the carrier in the region of the mounting. For mounting, the yoke can simply be pushed over the carrier from the mounting. The yoke is subsequently guided axially in the region of the mounting and on the guide rail.

To prevent the yoke from tilting, the guide element may be made particularly wide. However, because of this, the guide element has a high weight and a large bearing surface on the guide rail. The large bearing surface leads to undesirable frictional losses during the pivoting movement of the yoke. According to another aspect of the invention, a tilting of the yoke can be prevented in a simple way by two fork-shaped guide elements arranged next to one another, without the weight of the yoke being appreciably increased thereby.

According to another aspect of the invention, the yoke is mounted in a particularly simple way when a spring element prestressing the wiper contact against the wiping track of the potentiometer is fastened between the guide elements arranged next to one another.

A deformation of the guide rail could lead to the wiper contact being lifted off from the wiping track or to a rubbing of the guide element. According to another aspect of the invention, the guide rail has very high stability when it has a projecting edge.

The filling-level sensor according to the invention is manufactured particularly cost-effectively when the guide rail is at a greater or equal distance from the carrier at its end facing away from the mounting than at its end facing the mounting, and when surfaces of the carrier and of the guide rail which face one another in each case have a plane configuration. By virtue of this configuration, the carrier can be manufactured, together with the guide rail, in a very simple way from plastic by the injection molding method in an injection mold from which removal can easily take place axially.

According to another aspect of the invention, the carrier requires the use of a particularly small amount of material when the guide rail is held at its ends by holding parts in front of the carrier.

### BRIEF DESCRIPTION OF THE DRAWINGS

FIG. 1 shows a perspective illustration of a filling-level sensor according to the invention,

FIG. 2 shows a sectional illustration through the filling-level sensor from FIG. 1 along line II-II,

FIG. 3 shows a further embodiment of the filling-level sensor according to the invention in a longitudinal section through a yoke.

### DETAILED DESCRIPTION OF THE PREFERRED EMBODIMENTS

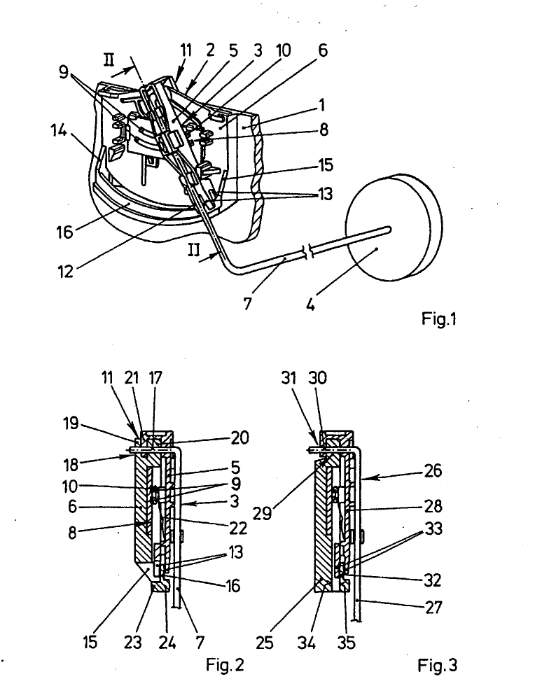

FIG. 1 shows a filling-level sensor 2 according to the invention, mounted on a vertical wall 1 within a fuel tank. The filling-level sensor 2 has a float 4 fastened to a lever arm 3. The lever arm 3 is mounted pivotably on a carrier 6 by a yoke 5 made from plastic and has a lever wire 7, fastened to the yoke 5, for holding the float 4. The float 4 follows a fuel level in the fuel tank and at the same time pivots the lever arm 3. The pivoting angle of the lever arm 3 is detected by a potentiometer 8. The potentiometer 8 has two wiping tracks 9 arranged on the carrier 6 and a wiper contact 10 fastened to the yoke 5. The wiper contact 10 is designed as a double contact for bridging the wiping tracks 9. To guide the yoke 5 in an intended axial position in relation to the carrier 6, the yoke 5 engages behind the carrier 6 in the region of a mounting 11. The yoke 5 has, at its end facing away from the mounting 11, two fork-shaped guide elements 12, 13 which are arranged next to one another and which engage with a guide rail 16 fastened laterally to the carrier 6 by holding parts 14, 15. By the yoke 5 being guided in the intended axial position in relation to the carrier 6, the wiper contact 10 is reliably prevented from being lifted off from the wiping tracks 9.

FIG. 2 shows a filling-level sensor 2 according to the invention from FIG. 1 in a sectional illustration along the line can be seen here that the II-II. FIG. 2 illustrates that the lever wire 7 forms, in the region of the mounting 11 of the yoke 5, an angled portion 17 functioning as a bearing axle for the lever arm 3. The carrier 6 has a bearing bore 18 comprising two parts 19, 20. A free end of an engaging-around portion 21 of the yoke 5 is arranged between the two parts 19, 20 of the bearing bore. The wiper contact 10 is prestressed against the wiping tracks 9 by a tongue-shaped spring element 22. The tongue-shaped spring element 22 is fastened to the yoke 5 between to two fork-shaped guide elements 12, 13. To increase the stability of the guide rail 16, the latter has two vertically projecting edges 23, 24.

FIG. 3 shows a further embodiment of the filling-level sensor according to the invention, with a lever arm 26 pivotable on a carrier 25 in a mounting 31. The lever arm 26 has a yoke 28 snapped together with a lever wire 27. The carrier 25, here, has a one-part bearing bore 29, behind which an angled portion 30 of the yoke 28 is engaged. At the end facing away from the mounting 31, the yoke 28 has a fork-shaped guide element 33 which engages with a guide rail 32 of the carrier 25. The guide rail 32 and a region of the carrier 25 which faces the guide rail 32 has plane surfaces 34, 35 arranged parallel to one another.

1. A filling-level sensor for generating electrical signals as a function of a pivoting angle of a float-carrying lever arm for a tank of a motor vehicle, comprising:
a carrier for fastening to a lateral wall in the tank;
a yoke made of plastic and pivotable in a mounting of the carrier;
a lever wire holding a float and fastened to the yoke; and
a guide rail, arranged on the carrier, for guiding a guide element of the yoke in an intended axial position in relation to the carrier, wherein
the guide rail is arranged so as to point in the direction of the mounting, and the yoke has a fork-shaped guide element which is open at an end facing away from the mounting and which is in engagement with the guide rail.

2. The filling-level sensor as claimed in claim 1, wherein the guide rail has a web-shaped configuration and is arranged parallel to the carrier.

3. The filling-level sensor as claimed in claim 1, wherein the fork-shaped guide element is arranged at the end of the yoke which faces away from the mounting.

4. The filling-level sensor as claimed in claim 1, wherein the yoke is designed to engage around at least part of the carrier in the region of the mounting.

5. The filling-level sensor as claimed in claim 1, wherein two fork-shaped guide elements are arranged next to one another.

6. The filling-level sensor as claimed in claim 1, further comprising a spring elements prestressing a wiper contact against a wiping track of a potentiometer fastened between the guide elements arranged next to one another.

7. The filling-level sensor as claimed in claim 1, wherein the guide rail has a projecting edge.

8. The filling-level sensor as claimed in claim 1, wherein the guide rail is at a greater or equal distance from the carrier at its end facing away from the mounting than at its end facing the mounting, and in that surfaces of the carrier and of the guide rail which face one another in each case have a plane configuration.

9. The filling-level sensor as claimed in claim 1, wherein the guide rail is held at its ends by holding parts in front of the carrier.
